(19) United States
(12) Patent Application Publication
(10) Pub. No.: US 2015/0000565 A1
(43) Pub. Date: Jan. 1, 2015

(54) SURFACE COATED PIGMENT PARTICLES

(71) Applicant: PPG Industries Ohio, Inc., Cleveland, OH (US)

(72) Inventors: Joseph T. Valko, Pittsburgh, PA (US); Michael Zalich, Pittsburgh, PA (US); Peter Kamarchik, Saxonburg, PA (US)

(21) Appl. No.: 13/927,132

(22) Filed: Jun. 26, 2013

(51) Int. Cl. C09C 1/36; B05D 5/06

(52) U.S. Cl. CPC C09C 1/3661; B05D 5/06
USPC 106/444; 427/212; 427/219

(57) ABSTRACT

Disclosed is a method of surface coating pigment particles, comprising treating uncoated titanium dioxide particles with a reaction product of a silicon oxide with an alkaline earth metal salt to form a coating comprising an oxide of silicon and the alkaline earth metal. The particles may also be treated with aluminum compounds to produce an aluminum oxide in the coating.

### FIELD OF THE INVENTION

This invention relates to methods of surface treating pigment particles. In particular, the invention relates to surface treatment of titanium dioxide with alkaline earth metal silicate species.

### BACKGROUND OF THE INVENTION

Metal oxides such as titanium dioxide (TiO₂) and zinc oxide are commonly used in several industrial fields. For example, TiO₂ is used as an opacifier and/or white pigment in the coatings industry, as filler material in plastics, and as a photocatalyst for removing environmental pollutants. In the coatings industry, TiO₂ pigments provide efficient scattering of light to impart brightness and opacity. Titanium dioxide is typically commercially available in the anatase and rutile crystalline forms. Rutile TiO₂ is particularly desired because it scatters light more effectively and is more durable than the anatase form.

Titanium dioxide (rutile and anatase) has traditionally been produced by two commercial processes, referred to herein as the “sulfate process” and the “chloride process”. In the sulfate process, titanium ore is treated with sulfuric acid followed by crystallization and precipitation of TiO₂. In the chloride process, titanium ore is treated with chlorine gas to produce an intermediate of TiCl₄, which is oxidized to form TiO₂, which is referred to herein as “the chloride process”. Other processes for producing TiO₂ using chloride may involve solvent extraction, followed by precipitation and calcination. The raw TiO₂ produced by any of these processes is often surface treated with inorganic materials, such as silica and/or aluminum oxide, to protect the organic carriers in which the TiO₂ is used from degradation upon exposure to ultraviolet radiation, and with organic materials to enhance dispersability in organic carriers, such as coating compositions.

In general, TiO₂ produced via the chloride process exhibits more desirable properties than TiO₂ that is produced using the sulfate process. In particular, in certain coating compositions, the tint strength and gloss achieved using TiO₂ produced via a sulfate process is less than for TiO₂ that is produced using the chloride process, even with post-production surface treatment.

### SUMMARY OF THE INVENTION

The present invention includes pigment particles coated at least in part with a coating comprising a reaction product of reactants comprising an oxide of silicon and a salt of an alkaline earth metal. Also included in the present invention is a method of preparing pigment particles comprising treating uncoated pigment particles with a silicon compound and an alkaline earth metal compound to form an alkaline earth metal silicate on the particles.

Coated titanium dioxide pigment of the present invention that is produced from a process other than the chloride process has a tint strength that is at least equal to the tint strength of titanium dioxide pigment produced in a chloride process, wherein the coated titanium dioxide pigment comprises a coating comprising a reaction product of silicon oxide and a salt of an alkaline earth metal.

### DETAILED DESCRIPTION OF THE INVENTION

For purposes of the following detailed description, it is to be understood that the invention may assume various alternative variations and step sequences, except where expressly specified to the contrary. Moreover, other than in any operating examples or where otherwise indicated, all numbers expressing, for example, quantities of ingredients used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

The present invention is directed to post-production surface treatment of pigment particles and is described in reference to treatment of uncoated titanium dioxide particles. This is not necessarily meant to be limiting, as other pigment particles (which may be inorganic pigment particles) may be treated using the surface treatment of the present invention, such as particles of silicon dioxide, barium titanate, zinc oxide and other such surface treatable pigment particles. By “post-production” surface treatment of titanium dioxide particles, it is meant treatment of raw TiO₂ particles after being produced in a sulfate process or a chloride process or other such process, without further surface treatment such that the TiO₂ particles are uncoated. By “uncoated” it is meant that the particles do not have any coating applied thereto prior treatment according to the present invention. Unless specifically indicated to the contrary, the TiO₂ particles referred to herein are uncoated TiO₂particles.

In one embodiment, the surface treatment process of the present invention involves use of an aqueous dispersion or suspension of TiO₂ particles, such as a wet-milled suspension of TiO₂ particles. Typically, wet milling is performed in the presence of a dispersing agent. In one embodiment of the invention, TiO₂ particles are surface treated with an alkaline earth silicate oxide, such as calcium silicate or magnesium silicate. The present invention involves the use of multiple components that are initially soluble in an aqueous system, but which react and precipitate onto the TiO₂ particles. In this manner, water soluble components become water insoluble and deposit on the TiO₂ particles.

In one embodiment, an oxide of silicon and an alkaline earth metal salt, such as a calcium salt and/or a magnesium salt, are added to the suspension of TiO₂ particles in the form of aqueous solutions. By “an oxide” or “a salt”, it is meant to include one or more of such compounds. Suitable silicon oxides are provided as alkaline water soluble salts, such as sodium silicate. Suitable alkaline earth metal salts are water soluble salts such as calcium chloride, magnesium chloride and/or magnesium sulfate. It should be appreciated that additions of a base such as NaOH may be added to maintain the pH. The oxide of silicon and the salt of an alkaline earth metal can be added to the suspension in any desired order, such as individually, in succession or simultaneously. It is believed that the addition of a silicate salt and an alkaline earth metal salt results in the production of a silicate of the alkaline earth metal. For example, addition of sodium silicate and calcium chloride to a basic solution containing TiO₂ particles yields calcium silicate. With further addition of the silicate salt, any remaining calcium salt is reacted and forms additional calcium silicate. It should be appreciated that additions of a base such as NaOH may be added to adjust the pH. For example, upon reaction of sodium silicate and calcium chloride, the reaction product of calcium silicate deposits onto the TiO₂ particles. Any excess calcium chloride remaining in solution may lower the pH. Addition of a base to raise the pH may benefit the subsequent addition and reaction of sodium silicate. In general, the pH of the suspension during the sulfate treatment process may be maintained in the range of 3-8. The pH of the suspension may be adjusted as needed to achieve reaction of the silicon oxide and alkaline earth metal salt. In this manner, it is believed that the resulting coating comprises products resulting from the reaction of a silicon oxide species and a salt of an alkaline earth metal, without the formation of separate layers of silicon oxide and oxides of alkaline earth metals.

In certain embodiments, after coating the TiO₂ particles with the products of reaction of a silicon oxide species and a salt of an alkaline earth metal, a suitable aluminum compound, such as an alkaline-reacting, water-soluble salt such as aluminum sulfate, aluminum nitrate, aluminum chloride, aluminum acetate and the like, may be added, along with further base (such as NaOH) for pH adjustment (as described above), to ultimately produce an aluminum oxide in an outermost portion of the coating on the TiO₂ particles, although some aluminum hydroxide content might remain. As a result, the TiO₂ particles may be coated with a coating including a reaction product of silicon oxide and a salt of an alkaline earth metal and an aluminum oxide.

In another embodiment, a transition metal such as zirconium may be introduced using a zirconium salt such as zirconium oxychloride in an acidic solution or zirconium sulfate. Upon the addition of a hydroxide (such as NaOH), a zirconium oxide compound precipitates onto the titanium dioxide particles, and subsequent addition of an oxide of silicon and an alkaline earth metal salt, such as magnesium chloride, can result in the precipitation of the product of their reaction (magnesium silicate) to form a second layer.

The total quantity of alkaline earth metal added to the suspension by way of the various alkaline earth metal compounds is 0.5-2.0 wt. %, resulting in deposition on the pigment particles of 0.3-2.0 wt. % of the total weight of the pigment particles, calculated as an alkaline earth metal oxide. The total amount of silicon added to the suspension via the various silicon compounds (such as silicon oxides) is 0.2-1.5 wt. %, resulting in deposition on the pigment particles of 0.1-1.5 wt. % of the total weight of the pigment particles, calculated as silicon dioxide. Likewise, the aluminum may be added to the suspension in the amount of 1.0-3.0 wt. %, resulting in deposition on the pigment particles of 0.5-3.0 wt. % of the total weight of the pigment particles, calculated as Al₂O₃.

The coated TiO₂ particles produced by the process of the present invention are separated from the suspension by filtration methods that are known in the art and the resulting filter cake is washed to remove any remaining water soluble salts. The coated particles may be treated such as by milling in a steam jet mill or the like and an organic compound can be added to the coated pigment particles to cover at least a portion of the TiO₂ particles with an organic compound, which may cover substantially all of the surfaces particles (including the coated portions and any uncoated portions) and/or the entireties of the surfaces of the particles. Suitable organic materials include trimethylolpropane (TMP), triethanolamine (TEA), trimethylolethane (TME) or pentaerythritol and the like. These materials may be added to the pigment particles during steam or air milling. In one embodiment, TMP is added in an amount to produce about 0.2 to 0.5 wt. % based on the total weight of the coated TiO₂ pigment particles.

It has been discovered that, when added to a coating composition, the pigment particles treated according to the present invention provide excellent gloss and tint strength to the coating composition. As such, these pigments are suitable for use in paints, plastics and coatings where gloss, hiding and durability are desired. It has been found that TiO₂ particles produced according to the sulfate process that are treated according to the present invention evidence gloss and tint strength that achieve or exceed the gloss and tint strength of TiO₂ particles produced according to the chloride process.

Tint strength is determined with a spherical spectrophotometer, such as Xrite Color Eye i7 or Konica Minolta CM 3600d, by comparing the tint strength of a tinted composition such as a latex in comparison to a tinted latex produced with commercially available chloride process TiO₂ pigment particles via the chloride process. Gloss is determined by methods known in the art by incorporating the pigment into paint and measuring the gloss using a glossmeter and comparing it to the gloss of an untinted formulation.

### EXAMPLES

The following examples are presented to demonstrate the general principles of the invention. All amounts listed are described in parts by weight, unless otherwise indicated. The invention should not be considered as limited to the specific examples presented.

### Comparative Example 1

Into a one-gallon baffled reactor was charged 805.7 grams (g) of a 33.1% solids water slurry of uncoated, micronized, sulfate process titanium dioxide pigment which had been Eiger-milled with 1% sodium hexametaphosphate (CALGON®), the pH having been adjusted to 10.4 prior to milling. Deionized water was added to reduce the solids content to 20%. To the agitated (about 800 rpm) slurry at ambient temperature was added 5.8 g of a sodium silicate solution (23% silicon dioxide by weight) diluted with 7.5 g of deionized water. This was followed by addition of a solution of 27.8 g of aluminum sulfate hydrate (commercially available grade for swimming pool water treatment, “pool alum”) in 31.2 g of deionized water. The stirred slurry was then heated to 85° C. At 85° C., caustic (NaOH) was added to raise the pH to the 6.0-6.5 range and held for one hour. At that point, a repeat addition of the diluted sodium silicate solution followed by a repeat addition over about 15 minutes of the aluminum sulfate solution were introduced, followed by adjustment of the pH to the 5.5-6.0 range. A temperature of 85° C. was maintained for 30 minutes, followed by adjustment to a pH of 7.4, which was held at 85° C. for one hour. The slurry was cooled and rinsed with deionized water until the rinse water evidenced a conductivity of less than 100μ Siemens/cm. The pigment was reslurried, 2.8 g of trimethylolpropane was added, and the slurry was dried in a forced air oven at 110° C. The dried pigment was then jet milled with 60 psi air pressure. The jet milled pigment was evaluated as a complete replacement for a commercially available chloride process titanium dioxide pigment (Millenium CR826) in a MANOR HALL® latex paint. MANOR HALL® paint is a commercially available product of PPG Industries, Inc.

### Example 2

Into a one-gallon baffled reactor was charged 891.8 g of a 33.1% solids water slurry of uncoated, micronized, sulfate process titanium dioxide pigment which had been Eiger-milled with 1% sodium hexametaphosphate, the pH having been adjusted to 10.4 prior to milling. Deionized water was added to reduce the solids content to 20%. To the agitated slurry at ambient temperature was added a solution of 9.6 g of a sodium silicate solution (23% silicon dioxide by weight) which had been diluted with 8.3 g of deionized water. This was followed by a solution of 9.3 g of anhydrous calcium chloride which had been dissolved in 34.6 g of deionized water. The slurry was then heated to 85° C. At 85° C., a 10% caustic (NaOH) solution was used to adjust the pH to the 6.0-6.5 range. It was held at 85° C. for 1 hour, then a second solution of sodium silicate, identical to the first, was added, followed by a solution of 46.1 g of aluminum sulfate hydrate (pool alum) dissolved in 51.9 g of deionized water over about 15 minutes. The pH was then raised to the 5.5-6.0 range with 10% caustic and held at 85° C. for 30 minutes, then to 7.4 with more caustic. This was held at 85° C. for one hour. The pigment slurry was rinsed with deionized water until the rinse water evidenced a conductivity of less than 100μ. Siemens/cm. The pigment was reslurried and 3.1 g of trimethylolpropane was added, and the slurry was dried in a forced air oven at 110° C. The dried pigment was jet milled with 60 psi air pressure and evaluated as a complete replacement for a commercially available chloride process titanium dioxide pigment (Millennium CR826) in a MANOR HALL® latex paint.

### Example 3

Into a one-gallon baffled reactor was charged 868.2 g of a 34% solids water slurry of uncoated, micronized, sulfate process titanium dioxide pigment which had been Eiger-milled with 1% sodium hexametaphosphate, the pH having been adjusted to 10.4 prior to milling. Deionized water was added to reduce the solids content to 20%. To the agitated slurry at ambient temperature was added a solution of 6.4 g of a sodium silicate (23% silicon dioxide by weight) which had been diluted with 8.3 g of deionized water. This was followed by addition of a solution of 23.8 g of magnesium chloride hexahydrate in 34.6 g of deionized water. The slurry was heated to 85° C. At 85° C., a 10% caustic (NaOH) solution was added to raise the pH to the 6.0-6.5 range. It was held at 85° C. for one hour. After the one hour hold, a solution of sodium silicate identical to the first was added, followed by a solution of 30.8 g of aluminum sulfate hydrate (pool alum) dissolved in 34.5 g of deionized water over about 15 minutes. The pH was then adjusted to the 5.5-6.0 range with the 10% caustic (NaOH) solution. This was held for 30 minutes, then the pH was adjusted to 7.4 and held for one hour. The pigment slurry was rinsed with deionized water until the rinse water evidenced a conductivity of less than 100μ Siemens/cm. The pigment was reslurried and 3.1 g of trimethylolpropane was added, followed by forced air oven drying at 110° C. The dried pigment was jet milled with 60 psi air pressure and evaluated as a complete replacement for a commercially-available chloride process titanium dioxide pigment in a MANOR HALL® latex paint.

### Example 4

Into a one-gallon baffled reactor was charged 937.8 g of a 34% solids water slurry of uncoated, micronized, sulfate process titanium dioxide pigment which had been Eiger-milled with 1% sodium hexametaphosphate, the pH having been adjusted to 10.4 prior to milling. To this was added 656.4 g of deionized water, and the agitated slurry was heated to 85° C. At 85° C. was added a solution of 7.6 g of a 20% by weight solution of zirconium oxychloride in HCl (available from Inframat Advanced Materials, LLC of Manchester, Conn.) diluted with 16.4 g of deionized water over about 15 minutes. After another 15 minutes, 10% sodium hydroxide solution was added to raise the pH to 7.9. Simultaneous additions of two solutions (one of 21.5 g of sodium silicate solution (23% silica by weight) in 34.2 g of deionized water, the other being 18.4 g of magnesium chloride hexahydrate in 37.4 g of deionized water) were conducted over about 90 minutes. After completion of the simultaneous additions, the slurry was held at 85° C. for 30 minutes, then 10% caustic solution was added to raise the pH to 7.4. This was held for one hour, then the pH was again adjusted to 7.4 and held for 30 minutes. The pigment slurry was then rinsed with deionized water until the rinse water evidenced a conductivity of less than 100μ Siemens/cm. The pigment was reslurried and 3.3 g of trimethylolpropane was added, followed by forced air oven drying at 110° C. The dried pigment was jet milled with 60 psi air pressure and evaluated as a complete replacement for a commercially available chloride process titanium dioxide pigment in a MANOR HALL® latex paint.

### Example 5

Into a one-gallon baffled reactor was charged 685.8 g of a 42.5% solids water slurry of uncoated, micronized, sulfate process titanium dioxide pigment which had been Eiger-milled with 1% sodium hexametaphosphate, the pH having been adjusted to 10.4 prior to milling. Deionized water, 771.6 g, was added to reduce the solids content to 20%. To the agitated slurry at ambient temperature was added a solution of 9.6 g of a sodium silicate solution (23% silicon dioxide by weight) which had been diluted with 8.2 g of deionized water. This was followed by a solution of 30.3 g of aluminum sulfate hydrate (pool alum) which had been dissolved in 34.2 g of deionized water. The slurry was then heated to 85° C. At 85° C., a 10% caustic (NaOH) solution was used to adjust the pH to the 6.0-6.5 range. It was held at 85° C. for 1 hour, then a second solution of sodium silicate, identical to the first, was added, followed by a solution of 45.5 g of aluminum sulfate hydrate dissolved in 51.2 g of deionized water over about 15 minutes. The pH was then raised to the 5.5-6.0 range with 10% caustic (NaOH) solution and held at 85° C. for 30 minutes, then to 7.4 with more caustic (NaOH) solution. This was held at 85° C. for one hour. The pigment slurry was rinsed with deionized water until the rinse water evidenced a conductivity of less than 100μ Siemens/cm. At that point, the pigment was reslurried and 3.0 g of trimethylolpropane was added and the slurry was dried in a forced air oven at 110° C. The dried pigment was jet milled with 60 psi air pressure and evaluated as a complete replacement for a commercially available chloride process titanium dioxide pigment.

The paint samples from the Comparative Example 1 and Examples 2-5 were tested for tint strength as reported in Table 1. Tint strength was measures as a percent of the tint strength of a MANOR HALL® latex incorporating TiO₂ produced using a chloride process, CR826 from Millenium.

TABLE 1

| | Comparative | | | | |
|---|---|---|---|---|---|
| | Example 1 | Example 2 | Example 3 | Example 4 | Example 5 |
| Tint | 92.23 | 103.61 | 98.57 | 99.08 | 95.16 |
| Strength | | | | | |
| (%) | | | | | |

While the preferred embodiments of the present invention are described above, obvious modifications and alterations of the present invention may be made without departing from the spirit and scope of the present invention. The scope of the present invention is defined in the appended claims and equivalents thereto.

What is claimed:

1. Pigment particles coated at least in part with a coating comprising a reaction product of reactants comprising an oxide of silicon and a salt of an alkaline earth metal.

2. The pigment particles of claim 1, wherein the pigment particles are uncoated prior to being at least partially coated with the coating.

3. The pigment particles of claim 2, wherein the pigment comprises titanium dioxide.

4. The pigment particles of claim 3, wherein the alkaline earth metal comprises calcium and/or magnesium.

5. The pigment particles of claim 3, wherein the coating further comprises an aluminum compound.

6. The pigment particles of claim 5, wherein the aluminum compound is present at least in an outermost portion of the coating.

7. The pigment particles of claim 6, further comprising an organic compound covering at least a portion of the coating.

8. The pigment particles of claim 3 wherein the alkaline earth metal compound comprises 0.3-2.0 wt. % of the total weight of the pigment particles calculated as an oxide of the alkaline earth metal.

9. The pigment particles of claim 3, wherein the silicon oxide comprises 0.1-1.5 wt. % of the total weight of the pigment particles calculated as SiO₂.

10. The pigment particles of claim 5, wherein the aluminum compound comprises 0.5-3.0 wt. % of the total weight of the pigment particles calculated as Al₂O₃.

11. The pigment particles of claim 3, wherein the uncoated titanium dioxide particles are produced by a sulfate process.

12. A method of preparing pigment particles comprising treating uncoated pigment particles with a silicon compound and an alkaline earth metal compound to form an alkaline earth metal silicate on the particles.

13. The method of claim 12, wherein the pigment particles comprise titanium dioxide.

14. The method of claim 13, further comprising treating the particles with an aluminum compound to form an aluminum oxide on the particles.

15. The method of claim 13, further comprising treating the particles with a transition metal compound to form an oxide of the transition metal on the particles.

16. The method of claim 13, wherein the silicon compound comprises water soluble silicate.

17. The method of claim 13, wherein the alkaline earth metal comprises calcium and/or magnesium.

18. The method of claim 17, wherein the calcium compound comprises a water soluble calcium salt.

19. The method of claim 17, wherein the magnesium compound comprises a water soluble magnesium salt.

20. The method of claim 13, wherein the uncoated titanium dioxide particles are provided in an aqueous suspension and the pH of the aqueous suspension is maintained at 3-8 during the treating steps.

21. A coated titanium dioxide pigment produced from a process other than the chloride process, said coated titanium dioxide pigment having a tint strength that is at least equal to the tint strength of titanium dioxide pigment produced via the chloride process, wherein said coated titanium dioxide pigment comprises a coating comprising a reaction product of a silicon oxide and a salt of an alkaline earth metal.

22. The pigment of claim 21, wherein said coating further comprises an aluminum oxide.

23. The pigment of claim 22, wherein said coating includes an inner region comprising a reaction product of reactants comprising an oxide of silicon and at least one salt of an alkaline earth metal and an outer region comprising said aluminum oxide.

24. The pigment of claim 21, wherein said process other than the chloride process comprises the sulfate process.
